(19) United States
(12) Patent Application Publication
(10) Pub. No.: US 2006/0272908 A1
(43) Pub. Date: Dec. 7, 2006

(54) Brake shoe key with integral stop

(76) Inventors: David M. East, Mundelein, IL (US); Zaheer M. Ahmed, Montgomery, IL (US); Richard W. Plegge, Palatine, IL (US)

Correspondence Address: Joel H. Bock;Cook, Alex, McFarron, Manzo,, Cummings & Mehler, Ltd., 200 West Adams Street - Suite 2850, Chicago, IL, 60606, US

(21) Appl. No.: 11/144,990

(22) Filed: Jun. 3, 2005

(51) Int. Cl. F16D 65/04

(52) U.S. Cl. 188/250 G; 188/250 D

(57) ABSTRACT

A brake shoe key for attaching a railroad car brake shoe to a brake head has a stop which engages the brake head to limit the insertion of the key into the brake head's keyway. The stop is located on the key so that when it engages the brake head the knee of the key will engage the lug of the brake shoe and the tang of the key will be spaced from the brake head. This correctly positions the key for retaining the brake shoe while leaving space between the tang and brake head to permit access with a prying tool for subsequent safe removal of the key.

### BACKGROUND OF THE INVENTION

Braking of a railroad freight car is accomplished with pneumatic cylinders acting through a series of mechanical linkages to force brake shoes against the car wheels as they rotate. Each brake shoe is mounted in what is called a brake head. A pair of brake heads are mounted on a brake beam, one brake head at each end of the brake beam so as to provide a brake shoe for each wheel of a wheel set. Brake shoes can wear quickly and are designed to be removable. A brake shoe is retained in the brake head by means of a spring steel piece called a brake shoe key. The key acts as a spring and tightly holds the brake shoe against the brake head. A brake shoe is installed by driving the key through adjacent openings in the shoe and head.

The configuration of the key is an industry standard, defined by AAR S-376, which has been in place for over twenty years. However, there are several problems with the design. In order for the key to properly retain the shoe, it must be driven all the way into the brake head, until the tang contacts the head. However, once a car is in service and a brake shoe needs to be replaced, removal of the key is difficult due to lack of access. To remove the key, one must pry it out by the tang. But the key itself is in an awkward position. It can be reached only through an opening in the side frame of the truck. If the key has been properly installed, i.e., it has been driven all the way in, it is difficult to get a lever under the tang for removing the key.

In order to avoid this problem, railroad workers have developed the practice of not driving the key all the way into the head. While this makes it easier to remove the key at a later time, the brake shoe is not properly retained in the head and there is a risk the shoe may be lost in service. The curved portion of the key that functions to hold the brake shoe to the brake head is not centered relative to the brake shoe's mounting lug. The resultant force holding the shoe in place is therefore lower than it should be. Furthermore, the key in this situation inter-faces with the brake shoe's mounting lug in an unintended, off-center location, which might contribute to the failure of either part.

One solution to this problem is to make the brake shoe key longer. This would allow it to remain part way out of the head for easy removal while also allowing for the correct interface between the key, the shoe and the head. But merely lengthening the key alone would add another possibility for improper installation of the key. It could be driven in too far, resulting in the same undesirable interface between the key and the shoe.

Although the tang on the current S-376 standard key does function as a stop to position the key correctly for proper retention of the brake shoe, it has the unintended consequence of making it difficult to remove correctly-installed keys. Other alternatives have been proposed without success. These alternatives have focused on changing the tang configuration and the interface between the brake shoe key and the external end of the brake head. One of these alternatives is provided in the S-376 standard. It changes the tang design. The stop in this design will not function correctly because many brake heads have no surface against which this type of tang may abut. Another recent proposal would make the tang a “C” shape. This would work as a stop but it has the drawback of not providing a solid surface on the key for striking with a hammer during installation. A further proposal includes a small stop similar to that in the present invention but intended to abut the exterior end of the brake head. This will not work because in the fully installed position the end of the key floats in the brake head opening, not touching either side of the opening. Field surveys have also revealed that the straight tang design needs to be improved since there is a tendency for the metal pry bar to slip during removal of the keys that may lead to injury.

The present invention provides a brake shoe key which solves these problems.

### SUMMARY OF THE INVENTION

A brake shoe key for railroad brake shoes has a shank with upper and lower legs and a tang at the end of the upper legs. A mechanical stop is formed on the upper leg so as to be engageable with a strut of the brake head to ensure that the key is driven to the proper distance to properly retain the shoe while at the same time leaving enough room between the tang and the brake head to facilitate removal of the key at a later time. A bend is formed on the upper leg to act as a visual indicator that the key has been driven to the proper distance. The end of the tang is bent 90 degrees to secure the pry bar and prevent it from slipping during removal of the keys.

### BRIEF DESCRIPTION OF THE DRAWINGS

FIG. 1 is a section through a brake head and brake shoe assembly, showing the brake shoe key of the present invention in its fully installed position.

FIG. 2 is a side elevation view of the brake shoe key of the present invention.

FIG. 3 is a front elevation view of the brake shoe key.

FIG. 4 is a section taken along line 4-4 of FIGS. 2 and 3.

FIG. 5 is a side elevation view of an alternate embodiment of a brake shoe key according to the present invention.

### DETAILED DESCRIPTION OF THE INVENTION

The brake shoe key of the present invention is illustrated generally at 10 in FIGS. 2-4. The key is made of spring steel as is conventional. Alternately, stainless steel could be used. The key 10 is an elongated shank having an upper leg 12 and a lower leg 14. The upper leg 12 is somewhat longer than the conventional brake shoe key. The upper and lower legs are joined at a knee 16. A stop 18 is formed on the outer or front face of the upper leg 12. In this embodiment the stop 18 is an integral protrusion in the center of the leg which may be formed by a stamping process or the like. It will be understood that the stop may be formed by other methods or apparatus such as a separate part suitably attached to the upper leg.

There is a tang 20 formed at the top of the upper leg 12. Preferably the tang is a folded-over portion that permits driving the key with a hammer and withdrawing it with a prying tool. The positions of the stop 18 and the tang 20 in relation to the knee 16 is important, as will be explained below. The key is completed by a foot portion 22 that includes a plurality of steps or corrugations 24. The corrugations will engage the bottom edge of a brake head and help retain the key in the fully installed position. A bend 26 is also formed on the upper leg to act as an indicator showing that the key has been installed properly when the bend 26 is no longer visible from the side. A small flange 28 is formed on the free end of the tang 20. The flange serves the purpose of securing a metal prying tool in place and preventing it from slipping off the tang during the removal of the key. This flange 28 is designed specifically to address the safety issue of pry bars slipping off during removal of the keys.

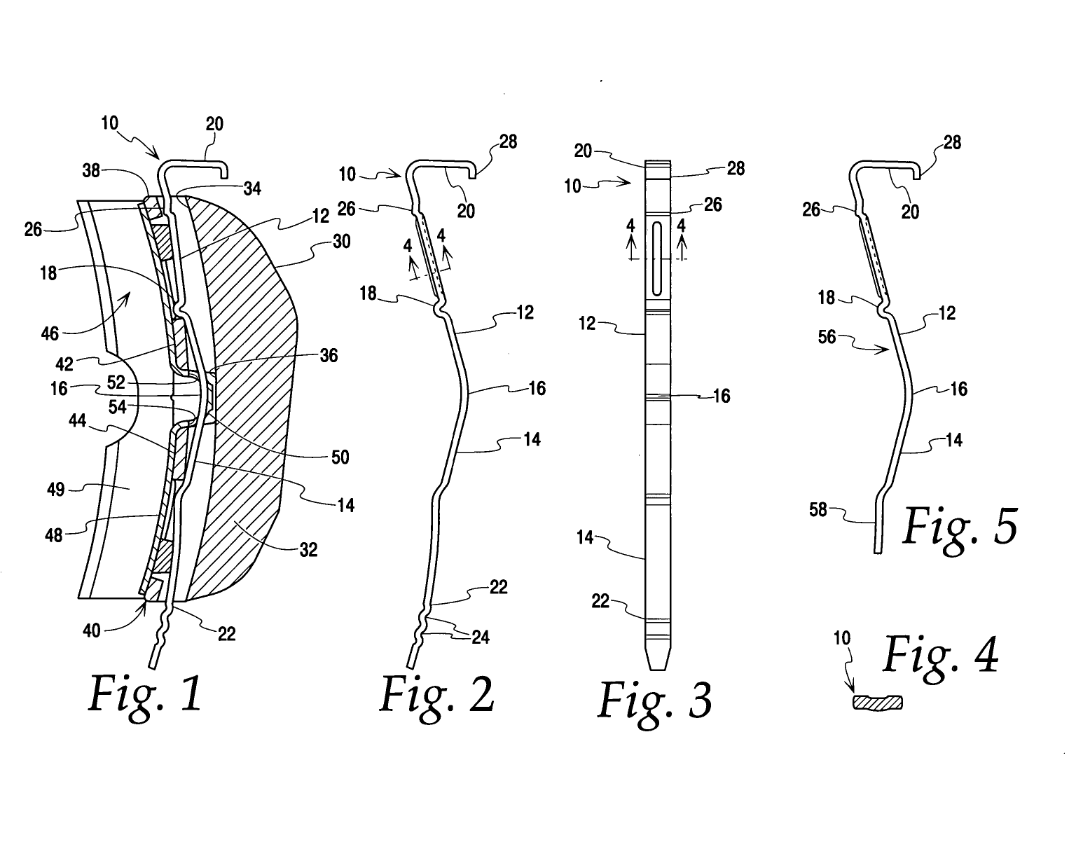

FIG. 1 illustrates the brake shoe key 10 in a fully-installed position wherein the key retains a brake shoe in a brake head. The brake head 30 includes a body 32 having a generally curved front face. It will be understood that the rear face of the brake head is attached to a brake beam (not shown) in the conventional manner. A keyway 34 is formed in the front face of the brake head 30. The keyway includes a well 36. A plurality of struts are attached to the brake head at its front face. These struts span the keyway 34. The struts include an entry strut 38 at the top of the keyway and an exit strut 40 at the bottom of the keyway. In addition there are upper and lower central struts 42 and 44 adjacent to the well 36.

The brake shoe 46 includes a backing plate 48 to which the brake shoe pad 49 is attached. The pad is made of suitable friction material. The backing plate 48 has a central mounting bridge or lug 50 with upper and lower slots 52 and 54 formed therein. When the shoe 46 is placed on the brake head 30 the lug 50 fits into the well 36 and the backing plate 48 engages the central struts 42, 44. This makes the brake shoe ready for retention by the brake shoe key 10.

The key 10 is inserted into the keyway 34 and driven downwardly. The foot 22 goes through the slots 52, 54 of the lug 50. The key is driven into the keyway until the stop 18 engages the upper central strut 42, as seen in FIG. 1. The stop will prevent further insertion of the key into the keyway. When the stop 18 engages the upper central strut 42 the key 10 will have reached its fully installed position. In this position the knee 16 engages the lug 50 and the tang 20 is spaced from the top of the brake head 30. The visual indicator bend 26 goes inside the keyway 34 and is no longer visible from the side, indicating that the key has been installed properly. This correctly positions the key for proper retention of the brake shoe and key while still leaving space between the tang and the brake head to safely use a prying tool for subsequent removal of the key. As mentioned above the relative locations of the knee 16, stop 18 and tang 20 are chosen so that the desired relationships exist when the key 10 is in its fully installed position.

FIG. 5 illustrates an alternate embodiment of the invention. This key 56 is similar to key 10 and common parts are identified by common reference numerals. Key 56 differs in that the foot 58 is shorter than foot 22 by 3.5 inches and the corrugations have been removed. This was designed for fully-enclosed tri-level autorack cars where there isn't enough clearance between the car base and the brake head to insert the key easily. The field car maintenance personnel struggle with using the standard 15 inch length keys on these cars. This one is easier to use in this particular application.

The present invention recognizes that the internal features where the head, the key and the shoe interface are much more uniform among the various commercially available designs than are the external features against which any tang-type stop must abut. For any key to work it must make contact at these interior surfaces in the manner shown in FIG. 1. The stop of the present invention ensures both proper retention of the key and ease of removal when the time comes to replace a worn out brake shoe.

While a preferred form of the invention has been shown and described, it will be realized that alterations and modifications may be made thereto without departing from the scope of the following claims.

We claim:

1. A brake shoe key for connecting a railroad brake shoe to a brake head, the brake head having a keyway defined therein which is spanned by a plurality of struts, the brake shoe having a key-receiving lug formed thereon and adapted for insertion into the keyway, the brake shoe key comprising:
an elongated shank having an upper leg portion and a lower leg portion;
a tang formed at one end of the upper leg portion; and
a stop formed on at least one of the leg portions, a fully-installed position of the key being defined when the key is inserted into the keyway and the stop engages one of the struts to prevent further insertion of the key, the stop and the tang being spaced from one another such that when the key is in the fully-installed position the tang is spaced from the brake head.

2. The brake shoe key of claim 1 further characterized in that the leg portions are joined at a knee, with the knee being located such that when the key is in the fully-installed position the knee engages the key-receiving lug of the brake shoe.

3. The brake shoe key of claim 1 wherein the stop is formed on the upper leg portion of the key.

4. The brake shoe key of claim 1 wherein the lower leg portion further includes a foot portion.

5. The brake shoe key of claim 1 wherein the keyway further comprises a well for receiving the brake shoe lug and there are upper and lower struts adjacent the well, the stop being located on the upper leg portion so as to be engageable with the upper strut.

6. The brake shoe key of claim 1 wherein the stop is characterized by a protrusion formed in the leg portion.

7. The brake shoe key of claim 1 further comprising a visual indicator formed on the upper leg in a location where the visual indicator is in the keyway when the key is in the fully-installed position.

8. The brake shoe key of claim 1 further comprising a flange formed on the tang.

9. A railroad car brake assembly, comprising:
a brake head having a keyway defined therein and a plurality of struts spanning the keyway;
a brake shoe having a key-receiving lug formed thereon and adapted for insertion into the keyway;
a brake shoe key for connecting the brake shoe to the brake head, the brake shoe key including an elongated shank having an upper leg portion and a lower leg portion, a tang formed at one end of the upper leg portion, and a stop formed on at least one of the leg portions, a fully-installed position of the key being defined when the key is inserted into the keyway and the stop engages one of the struts to prevent further insertion of the key, the stop and the tang being spaced from one another such that when the key is in the fully-installed position the tang is spaced from the brake head.

10. The brake shoe key of claim 9 further characterized in that the leg portions are joined at a knee, with the knee being located such that when the key is in the fully-installed position the knee engages the key-receiving lug of the brake shoe.

11. The railroad car brake assembly of claim 9 wherein the stop is formed on the upper leg portion of the key.

12. The railroad car brake assembly of claim 9 wherein the lower leg portion further includes a foot portion.

13. The railroad car brake assembly of claim 9 wherein the keyway further comprises a well for receiving the brake shoe lug and there are upper and lower struts adjacent the well, the stop being located on the upper leg portion so as to be engageable with the upper strut.

14. The railroad car brake assembly of claim 9 wherein the stop is characterized by a protrusion formed in the leg portion.

15. The railroad car brake assembly of claim 9 further comprising a visual indicator formed on the upper leg in a location where the visual indicator is in the keyway when the key is in the fully-installed position.

16. The railroad car brake assembly of claim 9 further comprising a flange formed on the tang.

17. In a brake shoe key for connecting a railroad brake shoe to a brake head, the brake head having a keyway defined therein which is spanned by a plurality of struts, the brake shoe having a key-receiving lug formed thereon and adapted for insertion into the keyway, the key being of the type having an elongated shank having an upper leg portion and a lower leg portion, and a tang formed at one end of the upper leg portion, an improved method of installing the brake shoe key, the improved method comprising the steps of:
forming a stop formed on at least one of the leg portions;
inserting the brake shoe lug into the keyway;
inserting the key into the keyway; and
driving the key into the keyway and into engagement with the brake shoe lug until the stop engages one of the struts, the stop and the tang being spaced from one another such that when the stop engages said strut the tang is spaced from the brake head.

18. The method of claim 17 further characterized in that the leg portions are joined at a knee, and when the stop engages said strut the knee engages the key-receiving lug of the brake shoe.

19. The method of claim 17 further characterized in that the keyway has a well for receiving the brake shoe lug and there are upper and lower central struts adjacent the well, the driving step being concluded when the stop engages the upper central strut.
